(19) United States
(12) Patent Application Publication
(10) Pub. No.: US 2026/0078842 A1
(43) Pub. Date: Mar. 19, 2026

(54) METHOD FOR CALCULATING WEAR AMOUNT BETWEEN ENGINE VALVE AND VALVE SEAT AND RELATED DEVICE

(71) Applicant: Harbin Engineering University, Heilongjiang (CN)

(72) Inventors: Xiujiang SHI, Heilongjiang (CN); Deliang HUA, Heilongjiang (CN); Fangpeng SHI, Heilongjiang (CN); Wanyou LI, Heilongjiang (CN); Xiqun LU, Heilongjiang (CN); Zhijun SHUAI, Heilongjiang (CN); Bin ZHAO, Heilongjiang (CN); Xuan MA, Heilongjiang (CN); Xiaoxiao LI, Heilongjiang (CN); Zehong CAI, Heilongjiang (CN)

(73) Assignee: Harbin Engineering University, Heilongjiang (CN)

(21) Appl. No.: 19/327,555

(22) Filed: Sep. 12, 2025

(30) Foreign Application Priority Data
Sep. 14, 2024 (CN) 202411297620.6

(51) Int. Cl. F16K 37/00; G06F 30/20

(52) U.S. Cl. CPC F16K 37/0083; G06F 30/20

(57) ABSTRACT

Provided are a method for calculating a wear amount between an engine valve and a valve seat and a related device. The method includes: establishing an impact wear model according to influence of an impact angle when an exhaust valve is seated; establishing a sliding wear model based on an Archard wear theory; then, calling the impact wear model and the sliding wear model, respectively, to calculate a normal impact wear amount, an impact slip wear amount and a sliding wear amount; and based on this, calculating a total wear amount between the exhaust valve and the valve seat. The above solution of the present disclosure fully takes into account various types of wear between the exhaust valve and the valve seat, for example, specifically dividing impact wear into normal impact wear and tangential impact slip wear, and also calculating sliding wear after the valve is closed.

### CROSS REFERENCE TO RELATED APPLICATION

This patent application claims the benefit and priority of Chinese Patent Application No. 202411297620.6, filed with the China National Intellectual Property Administration on Sep. 14, 2024, the disclosure of which is incorporated by reference herein in its entirety as part of the present application.

### TECHNICAL FIELD

The present disclosure relates to the technical field of the valve wear quantification, and in particular to a method for calculating a wear amount between an engine valve and a valve seat and a related device.

### BACKGROUND

An exhaust valve is repeatedly seated and impacts a valve seat during the operation of an engine, and is in contact with the valve seat due to a gas pressure in the cylinder during the closing period, thus bearing a large mechanical load and a large thermal load. At the same time, the lubrication condition at a contact between a valve and a valve seat is poor. In recent years, the strengthening degree of a diesel engine has been continuously improved, the emission requirements have been upgraded, the working environment of the valve and the valve seat has become worse, and wear is prone to occur between the valve and the valve seat, which leads to valve depression and a decrease in the sealing performance of the valve, seriously affecting the working performance of the diesel engine. Therefore, in order to establish an accurate wear model of an exhaust valve and a valve seat, precise calculation of the valve wear amount is crucial for the research and development of the diesel engine.

According to the dynamic analysis of the exhaust valve, it is known that when being closed, the valve is affected by a spring force of the valve, the valve impacts the valve seat at a specific speed, and the seating speed is usually between 0.2 m/s and 0.5 m/s. When the material surface is subjected to a high-speed instantaneous impact load, peeling, cutting or plastic deformation may occur, which may lead to material loss and surface morphology change. In addition to impact wear, the valve is subjected to a gas pressure in the cylinder when being closed to generate a large contact force between the valve and the valve seat, which may lead to deformation due to the contact between the valve and the valve seat and thus result in sliding wear. That is to say, from the microscopic point of view, the fatigue wear of the valve is a comprehensive effect of an impact wear mechanism and a sliding wear mechanism under a periodic alternating load, and is a macroscopic reflection of plastic deformation and micro-cracks on the surface of the valve. Therefore, accurately quantifying the wear amount when the valve is seated and the wear amount when the valve is closed is a prerequisite for accurately calculating a total wear amount of the exhaust valve.

### SUMMARY

An objective of the present disclosure is to provide a method for calculating a wear amount between an engine valve and a valve seat and a related device, which can accurately calculate the wear amount between the engine valve and the valve seat.

In order to achieve the above objective, the present disclosure provides the following solution.

In a first aspect, the present disclosure provides a method for calculating a wear amount between an engine valve and a valve seat, including the following steps:
establishing an impact wear model according to influence of an impact angle when an exhaust valve is seated; where the impact wear model includes a normal impact wear amount resulted from an impact normal force and an impact slip wear amount resulted from an impact tangential force;
establishing a sliding wear model based on an Archard wear theory; where in the sliding wear model, the sliding wear amount is directly proportional to a sliding distance and a normal load, respectively; and the sliding wear amount is inversely proportional to hardness of softer materials;
calling the impact wear model according to an impact force when the exhaust valve is seated, the number of impacts and the hardness of softer materials to calculate the normal impact wear amount and an impact slip wear amount;
calling the sliding wear model according to the normal load when the exhaust valve is closed, the sliding distance and the hardness of softer materials to calculate the sliding wear amount; and
calculating a total wear amount between the exhaust valve and the valve seat according to the normal impact wear amount, the impact slip wear amount and the sliding wear amount.

Optionally, calling the impact wear model according to the impact force when the exhaust valve is seated, the number of impacts and the hardness of softer materials to calculate the normal impact wear amount and the impact slip wear amount, specifically includes the following steps:
dividing the impact force when the exhaust valve is seated into an impact normal force and an impact tangential force according to the impact angle when the exhaust valve is seated;
calling the impact wear model based on the impact normal force and the number of impacts to calculate the normal impact wear amount;
calling the impact wear model based on the impact tangential force, the number of impacts and the hardness of softer materials to calculate the impact slip wear amount.

Optionally, the normal impact wear amount is calculated according to the following formula:

$${W}_{1} = {KNF}_{n}^{{n}_{ZLS}} .$$

where W₁ is the normal impact wear amount, K is a normal impact wear coefficient, Nis the number of impacts, Fₙ is the impact normal force, and n_{ZLS} is a normal impact wear index.

Optionally, the impact slip wear amount is calculated according to the following formula:

$${W}_{2} = k \frac{N \times {F}_{t}^{{m}_{ZLS}}}{H} ,$$

where W₂ is the impact slip wear amount, k is an impact slip wear coefficient, N is the number of impacts, x is an impact slip distance, Fₜ is the impact tangential force, H is the hardness of softer materials, and m_{ZLS} is a tangential impact slip index.

Optionally, the sliding wear amount is calculated according to the following formula:

$${W}_{3} = p \frac{Fl}{H} ,$$

where W₃ is the sliding wear amount, p is the probability of generating wear particles in a micro-bulge, F is a normal load, l is a sliding distance, and H is the hardness of softer materials.

Optionally, the method further includes:
determining the hardness of softer materials at the current temperature according to the influence of temperature on the hardness of metal materials and the current temperature.

Optionally, the hardness of softer materials at the current temperature is determined according to the following formula:

$$H ( T ) = {H}_{0} \cdot {e}^{- β \cdot T} ,$$

where H(T) is the hardness of softer materials at the current temperature, Tis the current temperature, H₀ is the hardness of softer materials at the room temperature, e is impact energy, and β is a constant related to characteristics of softer materials.

In a second aspect, the present disclosure provides a computer device, including: a memory, a processor and a computer program stored in the memory and executable on the processor, where the processor executes the computer program to implement the steps of the method for calculating the wear amount between the engine valve and the valve seat described above.

In a third aspect, the present disclosure provides a non-transitory computer-readable storage medium, on which a computer program is stored, where the computer program, when executed by a processor, implements the steps of the method for calculating the wear amount between the engine valve and the valve seat described above.

In a fourth aspect, the present disclosure provides a computer program product, including a computer program, where the computer program, when executed by a processor, implements the steps of the method for calculating the wear amount between the engine valve and the valve seat described above.

According to the specific embodiment provided by the present disclosure, the present disclosure discloses the following technical effects.

The present disclosure provides a method for calculating a wear amount between an engine valve and a valve seat and a related device. The method includes: establishing an impact wear model according to influence of an impact angle when an exhaust valve is seated; establishing a sliding wear model based on an Archard wear theory; then, calling the impact wear model and the sliding wear model, respectively, to calculate a normal impact wear amount, an impact slip wear amount and a sliding wear amount; and calculating a total wear amount between the exhaust valve and the valve seat according to the normal impact wear amount, the impact slip wear amount and the sliding wear amount. The above solution of the present disclosure fully takes into account various types of wear between the exhaust valve and the valve seat, for example, specifically dividing impact wear into normal impact wear and tangential impact slip wear. Compared with the traditional solution that only takes into account the normal impact wear, the present disclosure is more accurate in terms of a calculation result of the impact wear amount, and is more in line with the actual situation. At the same time, the situation, in which the valve is subjected to a gas pressure in the cylinder when being closed to generate a large contact force between the valve and the valve seat, which may lead to deformation due to the contact between the valve and the valve seat and thus result in a sliding wear amount, is also taken into account, so that the total wear amount is more in line with the actual result, and a basis is provided for the improvement and research of a diesel engine.

### BRIEF DESCRIPTION OF THE DRAWINGS

In order to more clearly explain the technical solution in the embodiments of the present disclosure or the prior art, the drawings needed to be used in the embodiments will be briefly introduced below. Obviously, the drawings described below are only some embodiments of the present disclosure. For those skilled in the art, other drawings may be obtained according to these drawings without paying creative labor.

FIG. 1 is a flowchart of a method for calculating a wear amount between an engine valve and a valve seat according to an embodiment of the present disclosure.

FIG. 2 is a schematic diagram of seating between an engine valve and a valve seat in a method for calculating a wear amount between a valve and a valve seat according to an embodiment of the present disclosure.

FIG. 3 is a schematic diagram of an impact angle of an impact between a valve and a valve seat in a method for calculating a wear amount between an engine valve and a valve seat according to an embodiment of the present disclosure.

FIG. 4 is a schematic diagram of wear resulted from friction between two materials in a method for calculating a wear amount between an engine valve and a valve seat according to an embodiment of the present disclosure.

FIG. 5 is a basic schematic diagram of an Archard model in a method for calculating a wear amount between an engine valve and a valve seat according to an embodiment of the present disclosure.

FIG. 6 is a flowchart of Step A3 in a method for calculating a wear amount between an engine valve and a valve seat according to an embodiment of the present disclosure.

FIG. 7 is a schematic diagram of coating on a surface of a valve in a method for calculating a wear amount between an engine valve and a valve seat according to an embodiment of the present disclosure.

FIG. 8 is a schematic structural diagram of a computer device according to an embodiment of the present disclosure.

### DETAILED DESCRIPTION OF THE EMBODIMENTS

The technical solution in the embodiment of the present disclosure will be clearly and completely described with reference to the drawings in the embodiment of the present disclosure hereinafter. Obviously, the described embodiments are only some of the embodiments of the present disclosure, rather than all of the embodiments. Based on the embodiments in the present disclosure, all other embodiments obtained by those skilled in the art without paying creative labor belong to the scope of protection of the present disclosure.

To make the above objective, features and advantages of the present disclosure more obvious and understandable, the present disclosure will be further described in detail with reference to the drawings and the specific implementations.

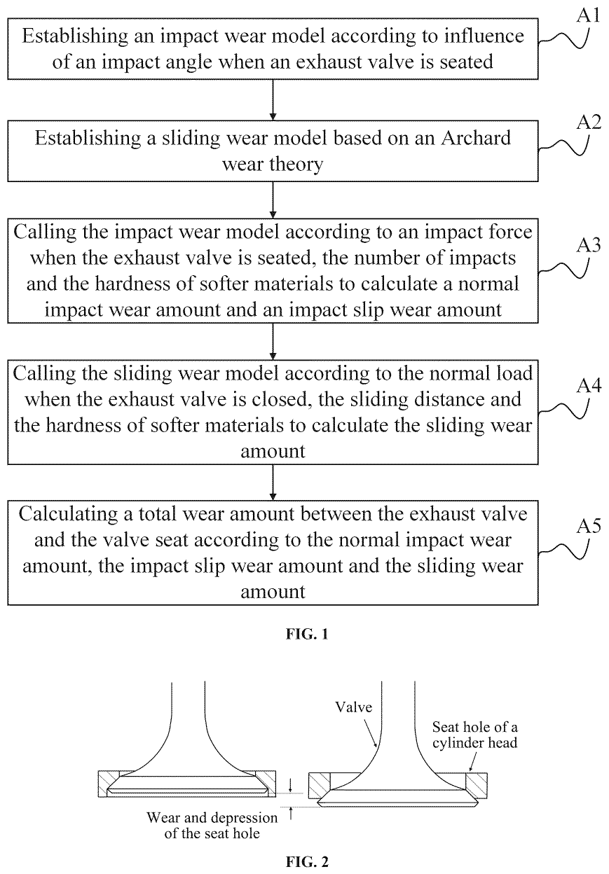

In an exemplary embodiment, as shown in the flowchart of FIG. 1, a method for calculating a wear amount between an engine valve and a valve seat is provided, including the following steps.
A1. An impact wear model is established according to influence of an impact angle when an exhaust valve is seated; where the impact wear model includes a normal impact wear amount resulted from an impact normal force and an impact slip wear amount resulted from an impact tangential force.

In the process that a valve of the diesel engine valve is seated, the wear loss is resulted from a single or a plurality of impacts of the valve. The impact effect when the valve of the diesel engine is closed may produce wear characteristics such as deformation, dent, indentation and cracks on the surface of the valve and the valve seat. The valve repeatedly impacts the valve seat during the operation of the diesel engine, which may gradually aggravate the wear degree and produce fatigue cracks on the surface of the valve and the valve seat. At the same time, as shown in FIG. 2, because the contact between the valve and the valve seat is a conical contact, a force along the conical direction may be generated between the valve and the valve seat, which may lead to the extrusion of materials at an outlet end of an impact pit. Because the working environment has a high temperature, the exhaust valve experiences a decrease in material hardness and the toughness, and the materials with lower hardness are more likely to be worn due to the impact, while the materials with higher toughness may generate plastic deformation under the impact and be not prone to generating cracking.

Inspired by erosion wear models, most of the existing impact wear models consider that the wear amount is related to the impact speed or the impact energy. For example, Wellinger and Breckel have studied the wear amount of different metal materials under the impact of spherical steel balls, and have proposed a semi-empirical relation as shown in Formula (1):

$$W = {KNV}^{{n}_{wellinger}} \qquad ( 1 )$$

where W is the wear amount in the unit of mm³; K is the impact wear coefficient; N is the number of impact cycles; V is the impact speed; n_{wellinger} is the impact wear speed index in the method proposed by Wellinger.

Fricke and Allen have studied the impact wear of different types of steel by using a hammer impact wear device, and think that the wear amount is related to the impact energy, as shown in Formula (2):

$$W = {KNe}^{{n}_{Fricke}} \qquad ( 2 )$$

where n_{Fricke} is the impact wear speed index in the method proposed by Fricke, and e is impact energy. The calculation method is shown in Formula (3):

$$e = \frac{1}{2} {MV}^{2} \qquad ( 3 )$$

where M is the effective mass, and V is the impact speed.

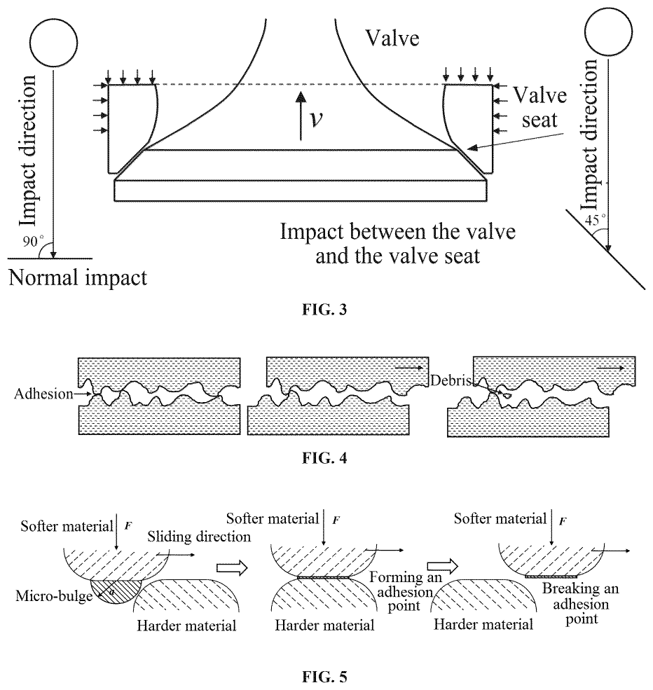

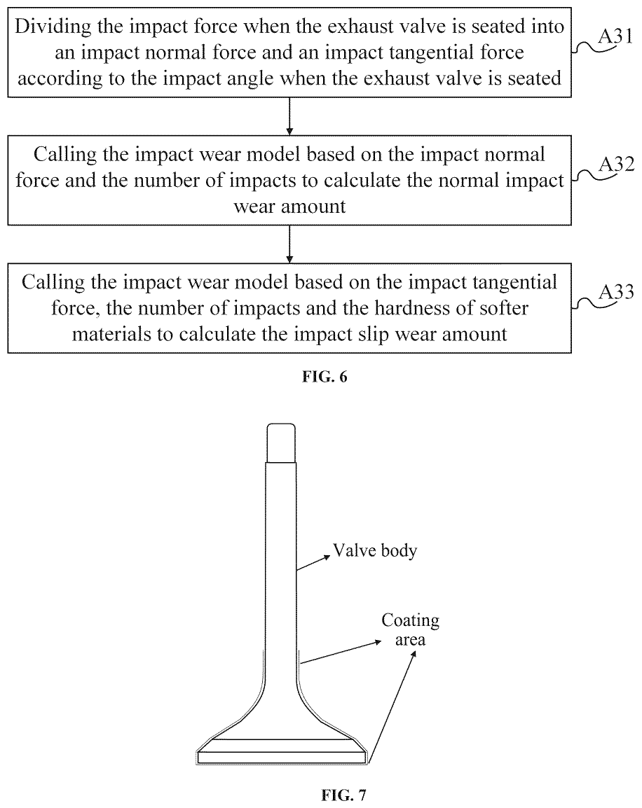

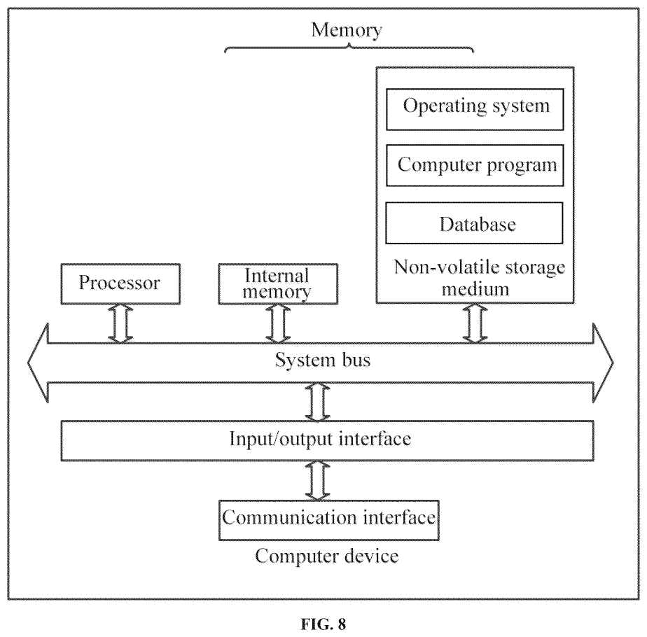

However, an erosion and wear theory is applicable to the random collision of fine solid particles with objects, which has a wide range of action. However, for the exhaust valve of a diesel engine, when the valve is seated, the conical surface of the valve collides with the inclined surface on the valve seat, resulting in a specific angle between the impact direction and the target surface. As shown in FIG. 3, compared with the common impact angle, there may be a tangential force in the parallel direction of the target surface. Therefore, in the present disclosure, when establishing the impact wear model of the valve and the valve seat, the impact angle is taken into account, and the impact wear amount of the valve is divided into two parts. The impact force of the valve is divided into two parts: a normal force and a tangential force. That is, the normal component and the tangential component along the inclined surface are calculated. respectively. The calculation model is shown in Formula (4):

$$\{ \begin{matrix}{W}_{1} = {KNF}_{n}^{{n}_{ZLS}} \\ {W}_{2} = k \frac{{NxF}_{t}^{{m}_{ZLS}}}{H}\end{matrix} \qquad ( 4 )$$

where W₁ is a normal impact wear amount, K is a normal impact wear coefficient, Nis the number of impacts, Fₙ is an impact normal force, and n_{ZLS} is a normal impact wear index; W₂ is an impact slip wear amount, k is an impact slip wear coefficient, x is an impact slip distance, Fₜ is an impact tangential force, H is the hardness of softer materials, and m_{ZLS} is a tangential impact slip index.

Mohanad Zalzalah and Roger Lewis have done a lot of impact tests on austenitic steel and medium carbon steel at different angles to verify the accuracy of the above model. The data from the impact wear coefficient and the related index in the impact wear model established in the present disclosure is used to calculate the impact wear of the valve. Specifically, the normal impact wear coefficient is K=1.85×10⁻⁹, the impact slip wear coefficient is k=1.45×10⁻⁷, normal impact wear index is n_{ZLS}=0.816, and the tangential impact slip index is m_{ZLS}=1.850.
A2. A sliding wear model is established based on an Archard wear theory; in the sliding wear model, the sliding wear amount is directly proportional to a sliding distance and a normal load, respectively; and the sliding wear amount is inversely proportional to hardness of softer materials.

Sliding wear on the contact surface between the valve and the valve seat is a common friction and wear form, that is, under a specific load, the materials on the contact surface are gradually worn out due to the relative movement of two objects in surface contact, as shown in FIG. 4. The Archard wear theory put forward by British engineers Duncan Dowson and John Archard is the most classic theory in the study of sliding wear and is widely used. In this embodiment, the sliding wear amount of the valve and the valve seat is calculated according to the wear model.

The basic principle of an Archard model is shown in FIG. 5. The surface of real materials has roughness. Two surfaces come into contact under a specific load. The micro-bulges on the surface of the material come into contact with and bear each other. The hardness of the two materials causing friction is different. The micro-bulges on the surface of the softer materials may produce adhesion points with the micro-bulges on the surface of the harder material. Assuming that the contact area of each adhesion point is πa², the normal load F of friction is borne by n identical micro-bulges with radius a.

When the material generates the plastic deformation, the relationship between the normal load F and the yield limit σ_{y} of the softer materials is as follows:

$$F = {σ}_{y} π {a}^{2} n \qquad ( 5 )$$

When there is relative sliding between two materials that generate friction, assuming that the wear debris generated by each micro-bulge during sliding is hemispherical and the volume is ⅔πa³, the total wear per unit slip distance can be calculated by Formula (6):

$$V = \frac{\frac{2}{3} π {a}^{3}}{2 a} \times n = \frac{π {a}^{2}}{3} n \qquad ( 6 )$$

The following Formula (7) can be obtained from Formula (5) and Formula (6):

$$V = \frac{F}{3 {σ}_{y}} \qquad ( 7 )$$

Formula (7) is derived on the assumption that each micro-bulge may generate a wear particle due to a sliding shear action when being in contact. Therefore, it is necessary to consider the probability of generating wear particles in the micro-bulge. It is assumed that the probability number is p. At the same time, the slip distance l in the unit of mm should also be taken into account. The final expression of the sliding wear amount on the contact surface is shown in Formula (8):

$$Q = k \frac{Fl}{3 {σ}_{y}} \qquad ( 8 )$$

For general elastic materials, the yield limit of the material is σ_{y}=H/3, H is Brinell hardness, and the calculation formula of the wear amount (mm³) can be changed into Formula (9):

$${W}_{3} = p \frac{Fl}{H} \qquad ( 9 )$$

According to the calculation formula of the Archard wear amount, the sliding wear amount of materials is directly proportional to a sliding distance l and a normal load F, respectively; and the sliding wear amount is inversely proportional to hardness H of softer materials.

In addition, the influence of temperature on the hardness of metal materials should be taken into account. The relationship between the hardness of metal materials and the temperature is as follows:

$$H ( T ) = {H}_{0} \cdot {e}^{- β \cdot T} \qquad ( 10 )$$

where H(T) is the hardness of softer materials at the current temperature, Tis the current temperature, H₀ is the hardness of softer materials at the room temperature, e is impact energy, and β is a constant related to characteristics of softer materials. The increase of temperature may lead to the decrease of the hardness of the surface of metal materials, which may aggravate the wear.
A3. The impact wear model is called according to an impact force when the exhaust valve is seated, the number of impacts and the hardness of softer materials to calculate a normal impact wear amount and an impact slip wear amount. As shown in the flowchart of FIG. 6, Step A3 specifically includes the following steps.
A31. The impact force when the exhaust valve is seated is divided into an impact normal force and an impact tangential force according to the impact angle when the exhaust valve is seated.
A32. The impact wear model is called based on the impact normal force and the number of impacts to calculate the normal impact wear amount.
A33. The impact wear model is called based on the impact tangential force, the number of impacts and the hardness of softer materials to calculate the impact slip wear amount.

In this embodiment, the wear amount between the valve and the valve seat after N impacts is taken into account, where the number of impacts N is 18,720,000, which is the service life of the valve commonly used in relevant literature.

According to the impact force when the valve impacts the valve seat when being seated, the impact normal force and the impact tangential force are calculated, as shown in Table 1.

TABLE 1
Magnitude of the impact force when the valve is seated

| | | | | Impact |
|---|---|---|---|---|
| | impact | Valve taper | Impact normal | tangential |
| | force (N) | angle (degree) | force (N) | force (N) |
| Mechanical | 6514 | 45 | 4606 | 4606 |
| impact | | | | |
| Thermal- | 8238 | 45 | 5825 | 5825 |
| mechanical | | | | |
| coupling | | | | |

According to the comparison of the results of the impact wear amount calculated from the parameter list shown in Table 2, it can be seen that the impact wear amount resulted from the collision of the valve with the valve seat under the simple mechanical load is 16.46 mm³, while the impact wear amount under the thermal-mechanical coupling is 24.33 mm³. The impact wear amount of the valve increases by 7.87 mm³ with the increase of temperature. It can be seen that the tangential component of the impact wear of the valve is greatly influenced by the temperature field.

TABLE 2
Calculation list of the impact wear amount when the valve is seated
The impact wear amount when the valve is seated (W = W1 +W2)

| Normal component (W₁ = KNFₙⁿ^{_{ZLS}}) | | | $Tangential component ( {W}_{2} = k \frac{{NxF}^{{m}_{ZLS}}}{{H}_{S}} )$ | | |
|---|---|---|---|---|---|
| Impact wear coefficient | 1.85 × 10⁻¹⁰ | | Impact sliding wear | 1.45 × 10⁻⁹ | |
| K | | | coefficient k | | |
| Number of impacts N | 18720000 | | Number of impacts N | 18720000 | |
| — | — | | slip distance x (mm) | Mechanical | 6.94 × 10⁻⁴ |
| | | | | impact | |
| | | | | Thermal- | 2.25 × 10⁻³ |
| | | | | mechanical | |
| | | | | coupling | |
| — | — | | Hardness of materials | 380 HB | |
| | | | HS | | |
| Index n_{ZLS} | 0.816 | | Index m_{ZLS} | 1.850 | |
| Normal force Fₙ (N) | Mechanical | 4606 | Normal force Fₜ (N) | Mechanical | 4606 |
| | impact | | | impact | |
| | Thermal- | 5734 | | Thermal- | 5734 |
| | mechanical | | | mechanical | |
| | coupling | | | coupling | |
| Normal impact wear | Mechanical | 14.71 | Impact slip wear | Mechanical | 1.75 |
| amount W₁ (mm³) | impact | | amount W₂ (mm³) | impact | |
| | Thermal- | 17.82 | | Thermal- | 6.51 |
| | mechanical | | | mechanical | |
| | coupling | | | coupling | |

| | | |
|---|---|---|
| Total impact wear | Mechanical | 16.46 |
| amount (mm³) | impact | |
| | Thermal- | 24.33 |
| | mechanical | |
| | coupling | |

A4. The sliding wear model is called according to the normal load when the exhaust valve is closed, the sliding distance and the hardness of softer materials to calculate a sliding wear amount. The calculation result of the sliding wear amount is shown in Table 3.

TABLE 3
Calculation result of the sliding wear amount

| | | Thermal-mechanical |
|---|---|---|
| | Mechanical load | coupling |
| Wear amount of a single | 4.05 × 10⁻⁶ | 1.76 × 10⁻⁵ |
| cycle (mm³) | | |
| Number of impacts | 18720000 | 18720000 |
| Total sliding wear | 33.03 | 143.61 |
| amount (mm³) | | |

According to the calculation result in Table 3, the sliding wear amount between the valve and the valve seat under the mechanical load action is 33.03 mm³, and the sliding wear amount between the valve and the valve seat under the thermal-mechanical coupling action is 143.61 mm³. After adding the temperature field, the sliding wear amount of the valve increases obviously.
A5. A total wear amount between the exhaust valve and the valve seat is calculated according to the normal impact wear amount, the impact slip wear amount and the sliding wear amount. The impact wear amount and the sliding wear amount of the valve are added to obtain the total wear amount of the valve, as shown in Table 4.

TABLE 4
Total wear amount between the exhaust valve and the valve seat

| | | Thermal-mechanical |
|---|---|---|
| | Mechanical load | coupling |
| Total wear amount (mm³) | 49.49 | 167.94 |

According to the calculation result in Table 4, compared with the mechanical load action, the valve wear amount increases by 239% (118.45 mm³) under the thermal-mechanical coupling after taking the temperature field into account, which shows that the temperature has a greater influence on the valve wear.

In an exemplary embodiment, a computer device is provided. The computer device may be a server or a terminal, and the internal structure diagram may be as shown in FIG. 8. The computer device includes a processor, a memory, an input/output interface (I/O for short) and a communication interface. The processor, the memory and the input/output interface are connected through the system bus, and the communication interface is connected to the system bus through the input/output interface. The processor of the computer device is configured to provide computing and control capabilities. The memory of the computer device includes a non-volatile storage medium and an internal memory. The non-volatile storage medium stores an operating system, a computer program and a database. The internal memory provides an environment for the operation of the operating system and the computer program in the non-volatile storage medium. The input/output interface of the computer device is configured to exchange information between the processor and the external device. The communication interface of the computer device is configured to communicate with an external terminal through network connection. The computer program, when executed by a processor, implements the steps of the method for calculating the wear amount between the engine valve and the valve seat mentioned in the above embodiment.

It can be understood by those skilled in the art that the structure shown in FIG. 8 is only a block diagram of a part of the structure related to the solution of the present disclosure, and does not constitute a limitation on the computer device to which the solution of the present disclosure is applied. The specific computer device may include more or less components than those shown in the figure, or combine some components, or have different component arrangements.

In an exemplary embodiment, a non-transitory computer-readable storage medium is provided, on which a computer program is stored. The computer program, when executed by a processor, implements the steps in the above method embodiments.

In an exemplary embodiment, a computer program product is provided, including a computer program. The computer program, when executed by a processor, implements the steps in the above method embodiments.

It should be noted that the user information (including but not limited to user equipment information, user personal information, etc.) and data (including but not limited to data for analysis, stored data, displayed data, etc.) involved in the present disclosure are all information and data authorized by users or fully authorized by all parties, and the collection, use and processing of relevant data must comply with relevant regulations.

Those skilled in the art can understand that all or part of the processes in the method of the above-mentioned embodiments can be completed by instructing relevant hardware through a computer program. The computer program can be stored in a non-volatile computer-readable storage medium. The computer program, when executed, can include the processes of the embodiments of each of the above-mentioned methods. Any reference to the memory, the database or other medium used in each of the embodiments provided by the present disclosure may include at least one of a non-volatile memory and a volatile memory. The non-volatile memory may include a Read-Only Memory (ROM), a magnetic tape, a floppy disk, a flash memory, an optical memory, a high-density embedded non-volatile memory, a Resistive Random Access Memory (ReRAM), a Magneto-Resistive Random Access Memory (MRAM), a Ferroelectric Random Access Memory (FRAM), a Phase Change Memory (PCM), a graphene memory, and the like. The volatile memory may include a Random Access Memory (RAM) or an external cache memory. By way of illustration and not limitation, the RAM can be in various forms, such as a Static Random Access Memory (SRAM) or a Dynamic Random Access Memory (DRAM).

The database involved in various embodiments provided by the present disclosure may include at least one of a relational database and a non-relational database. The non-relational database may include, but is not limited to, a distributed database based on a block chain. The processor involved in the embodiments provided by the present disclosure may include, but is not limited to, a general processor, a central processing unit, a graphics processing unit, a digital signal processor, a programmable logic device, a data processing logic device based on quantum computing, and the like.

Each of the technical features of the above embodiments can be combined at will. In order to make the description concise, not all possible combinations of the technical features in the above embodiments are described. However, as long as there is no contradiction between the combinations of these technical features, the combinations should be considered as the scope recorded in this specification.

In the present disclosure, specific examples are used to explain the principle and implementation of the present disclosure. The description of the above embodiments is only used to help understand the method and the core idea of the present disclosure. At the same time, for those skilled in the art, according to the idea of the present disclosure, there will be changes in the specific implementation and the application scope. To sum up, the contents of this specification should not be construed as limiting the present disclosure.

What is claimed is:

1. A method for calculating a wear amount between an engine valve and a valve seat, comprising:
establishing an impact wear model according to influence of an impact angle when an exhaust valve is seated; wherein the impact wear model comprises a normal impact wear amount resulted from an impact normal force and a slip wear amount resulted from an impact tangential force;
establishing a sliding wear model based on an Archard wear theory; wherein in the sliding wear model, the sliding wear amount is directly proportional to a sliding distance and a normal load, respectively; and the sliding wear amount is inversely proportional to hardness of softer materials;
calling the impact wear model according to an impact force when the exhaust valve is seated, the number of impacts and the hardness of softer materials to calculate the normal impact wear amount and an impact slip wear amount;
calling the sliding wear model according to the normal load when the exhaust valve is closed, the sliding distance and the hardness of softer materials to calculate the sliding wear amount; and
calculating a total wear amount between the exhaust valve and the valve seat according to the normal impact wear amount, the impact slip wear amount and the sliding wear amount;
wherein calling the impact wear model according to the impact force when the exhaust valve is seated, the number of impacts and the hardness of softer materials to calculate the normal impact wear amount and the impact slip wear amount, specifically comprises:
dividing the impact force when the exhaust valve is seated into a normal impact force and a tangential impact force according to the impact angle when the exhaust valve is seated;
calling the impact wear model based on the normal impact force and the number of impacts to calculate the normal impact wear amount; and
calling the impact wear model based on the tangential impact force, the number of impacts and the hardness of softer materials to calculate the impact slip wear amount;
wherein the normal impact wear amount is calculated according to the following formula:
$${W}_{1} = {KNF}_{n}^{{n}_{ZLS}} ,$$
wherein W₁ is the normal impact wear amount, K is a normal impact wear coefficient, Nis the number of impacts, Fₙ is a normal impact force, and n_{ZLS} is a normal impact wear index;
wherein the impact slip wear amount is calculated according to the following formula:
$${W}_{2} = k \frac{{NxF}_{t}^{{m}_{ZLS}}}{H} ,$$
wherein W₂ is the impact slip wear amount, k is an impact slip wear coefficient, N is the number of impacts, x is an impact slip distance, Fₜ is a tangential impact force, H is the hardness of softer materials, and m_{ZLS} is a tangential impact slip index.

2. The method for calculating the wear amount between the engine valve and the valve seat according to claim 1, wherein the sliding wear amount is calculated according to the following formula:
$${W}_{3} = p \frac{Fl}{H} ,$$
wherein W₃ is the sliding wear amount, p is the probability of generating wear particles in a micro-bulge, F is a normal load, l is a sliding distance, and H is the hardness of softer materials.

3. The method for calculating the wear amount between the engine valve and the valve seat according to claim 1, further comprising:
determining the hardness of softer materials at the current temperature according to the influence of temperature on the hardness of metal materials and the current temperature.

4. The method for calculating the wear amount between the engine valve and the valve seat according to claim 3, wherein the hardness of softer materials at the current temperature is determined according to the following formula:
$$H ( T ) = {H}_{0} \cdot {e}^{- β \cdot T} ,$$
wherein H(T) is the hardness of softer materials at the current temperature, Tis the current temperature, H₀ is the hardness of softer materials at the room temperature, e is impact energy, and β is a constant related to characteristics of softer materials.

5. A computer device, comprising: a memory, a processor and a computer program stored in the memory and executable on the processor, wherein the processor executes the computer program to implement the method for calculating the wear amount between the engine valve and the valve seat according to claim 1.

6. A computer-readable storage medium, on which a computer program is stored, wherein the computer program, when executed by a processor, implements the method for calculating the wear amount between the engine valve and the valve seat according to claim 1.

7. The computer device according to claim 5, wherein the sliding wear amount is calculated according to the following formula:
$${W}_{3} = p \frac{Fl}{H} ,$$
wherein W₃ is the sliding wear amount, p is the probability of generating wear particles in a micro-bulge, F is a normal load, l is a sliding distance, and H is the hardness of softer materials.

8. The computer device according to claim 5, further comprising:
determining the hardness of softer materials at the current temperature according to the influence of temperature on the hardness of metal materials and the current temperature.

9. The computer device according to claim 8, wherein the hardness of softer materials at the current temperature is determined according to the following formula:
$$H ( T ) = {H}_{0} \cdot {e}^{- β \cdot T} ,$$
wherein H(T) is the hardness of softer materials at the current temperature, Tis the current temperature, H₀ is the hardness of softer materials at the room temperature, e is impact energy, and β is a constant related to characteristics of softer materials.

10. The computer-readable storage medium according to claim 6, wherein the sliding wear amount is calculated according to the following formula:
$${W}_{3} = p \frac{Fl}{H} ,$$
wherein W₃ is the sliding wear amount, p is the probability of generating wear particles in a micro-bulge, Fis a normal load, l is a sliding distance, and H is the hardness of softer materials.

11. The computer-readable storage medium according to claim 6, further comprising:
determining the hardness of softer materials at the current temperature according to the influence of temperature on the hardness of metal materials and the current temperature.

12. The computer-readable storage medium according to claim 11, wherein the hardness of softer materials at the current temperature is determined according to the following formula:
$$H ( T ) = {H}_{0} \cdot {e}^{- β \cdot T} ,$$
wherein H(T) is the hardness of softer materials at the current temperature, Tis the current temperature, H₀ is the hardness of softer materials at the room temperature, e is impact energy, and β is a constant related to characteristics of softer materials.
